(19) United States
(12) Patent Application Publication
(10) Pub. No.: US 2026/0346786 A1
(43) Pub. Date: Nov. 5, 2026

(54) VEHICULAR REARVIEW MIRROR ALIGNMENT SYSTEM

(71) Applicant: Magna Electronics Inc., Auburn Hills, MI (US)

(72) Inventors: Pravin Jethawa, Novi, MI (US); Venu Gopal Thirakanam, Walled Lake, MI (US)

(21) Appl. No.: 19/659,468

(22) Filed: Apr. 27, 2026

Related U.S. Application Data
(60) Provisional application No. 63/798,827, filed on May 2, 2025.

(51) Int. Cl. B60R 1/02; B60R 1/04; B60R 1/062; B60R 1/12

(52) U.S. Cl. CPC B60R 1/025; B60R 1/04; B60R 1/062; B60R 1/12; B60R 2001/1253

(57) ABSTRACT

A vehicular driver monitoring system includes a camera. The vehicular driver monitoring system, responsive to processing at an ECU of image data captured by the camera, determines an eye position of a driver within an interior cabin of a vehicle. The vehicular driver monitoring system determines an orientation for a mirror reflective element of a rearview mirror of the vehicle based at least in part on (i) the determined eye position of the driver and (ii) a position of a driver's seat of the vehicle. The vehicular driver monitoring system adjusts the mirror reflective element of the rearview mirror of the vehicle using the determined orientation of the mirror reflective element of the rearview mirror of the vehicle.

### CROSS REFERENCE TO RELATED APPLICATION

The present application claims the filing benefits of U.S. provisional application Ser. No. 63/798,827, filed May 2, 2025, which is hereby incorporated herein by reference in its entirety.

### TECHNICAL FIELD

The present disclosure relates generally to a vehicle vision system for a vehicle and, more particularly, to a vehicle vision system that utilizes one or more cameras at a vehicle.

### BACKGROUND

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY

The present disclosure provides a vehicular driver monitoring system that includes a camera disposed at an interior cabin of a vehicle equipped with the vehicular driver monitoring system and viewing at least a portion of a driver of the vehicle. The camera is operable to capture image data. The camera includes an imager and an electronic control unit (ECU) with electronic circuitry and associated software. The electronic circuitry of the ECU includes an image processor for processing image data captured by the camera to detect presence of objects in the field of view of the camera. The ECU, responsive to processing by the image processor of image data captured by the camera, determines an eye position of the driver within the interior cabin of the vehicle. The vehicular driver monitoring system determines a configuration or orientation for a rearview mirror of the vehicle based at least in part on the determined eye position of the driver and a position of a driver's seat of the vehicle. The vehicular driver monitoring system adjusts the rearview mirror of the vehicle using the determined configuration or orientation of the rearview mirror.

These and other objects, advantages, purposes and features of the present disclosure will become apparent upon review of the following specification in conjunction with the drawings.

### BRIEF DESCRIPTION OF THE DRAWINGS

FIG. 1 is a plan view of a vehicle with a driver monitoring system that incorporates one or more cameras;

FIG. 2 is a perspective view of an interior rearview mirror assembly, showing an interior-viewing camera; and

FIG. 3 is a flowchart of a method for automatically aligning a rearview mirror of a vehicle via a driver monitoring system.

### DETAILED DESCRIPTION

Variations in height, body dimensions, and seating position among vehicle drivers may affect a view of a driver via a rearview mirror of the vehicle. Examples of body dimensions include torso length, neck length, and head size. Examples of seating position include a vertical seat height, a horizontal track position, and a seatback recline angle. The driver of the vehicle may adjust position, angle, and orientation of the rearview mirror to align a mirror reflective element of the rearview mirror with an eye position and a field of vision of the driver. Proper alignment of the mirror reflective element of the rearview mirror with the field of vision of the driver assists the driver in viewing objects, vehicles, and pedestrians through a rear window of the vehicle. The rearview mirror may comprise an interior rearview mirror assembly mounted within an interior cabin of the vehicle. In exemplary implementations, the rearview mirror comprises an exterior rearview mirror assembly mounted at an exterior of the vehicle. The alignment of the rearview mirror defines an orientation of the mirror reflective element, coordinating with a three-dimensional spatial location of the eye position of the driver and a position of a driver's seat of the vehicle.

A vehicle vision system, driving assist system, driver comfort system (DCS), or driver monitoring system (DMS) captures images of the interior cabin of the vehicle and may process captured image data to monitor vehicle occupants, display images, and detect objects within the vehicle or exterior to the vehicle. The vision system includes an image processor or image processing system receiving the image data from at least one camera and providing an output to a display device for displaying images representative of the captured image data. In exemplary implementations, the camera comprises a complementary metal-oxide-semiconductor (CMOS) imaging array having at least one million photosensors arranged in rows and columns. Processing the captured image data may include tracking eye movements, detecting facial landmarks, determining driver head pose, and calculating the eye position of the driver in three-dimensional space within the interior cabin of the vehicle. The display device may comprise a center console screen, a dashboard display, or a head-up display projecting information onto a windshield of the vehicle.

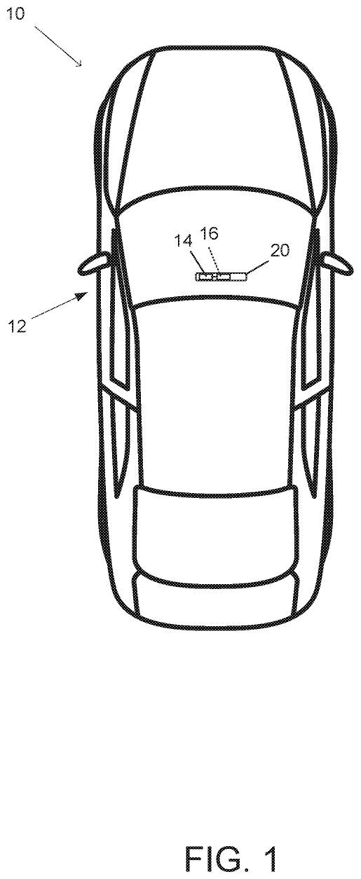

Referring to the drawings and the exemplary implementations depicted in the drawings, a vehicle 10 includes a cabin monitoring system, occupant monitoring system, or vehicular driver monitoring system 12 including at least one interior viewing imaging sensor or camera 14. The camera 14 has a lens for focusing images at or onto an imaging array, an imaging plane, or an imager of the camera 14 (FIG. 1). The imager may comprise the CMOS imaging array having at least one million photosensors arranged in rows and columns. The system 12 includes an electronic control unit (ECU) 16 comprising electronic circuitry and associated software. The electronic circuitry includes a data processor or image processor processing image data captured by the camera 14. The electronic circuitry may process image data captured by additional cameras at the vehicle 10, including exterior viewing cameras disposed at locations having respective fields of view exterior of the vehicle 10. The system 12 may provide an output to the display device for displaying video images for viewing by the driver of the vehicle 10. Although illustrated at an interior rearview mirror assembly 20 of the vehicle 10 in the exemplary implementations, a suitable position within the vehicle 10 may house the camera 14 and the ECU 16, along with optionally at least one near infrared (NIR) light emitter. Examples of suitable positions include a dashboard, a gauge cluster, an A-pillar, a steering column, a roof console, or a windshield mounted electronics module. Data transfer or signal communication from the camera 14 to the ECU 16 may comprise a suitable data or communication link. Examples of the data or communication link include a vehicle network bus of the equipped vehicle 10, a Controller Area Network (CAN) bus, a Local Interconnect Network (LIN), and an Automotive Ethernet connection.

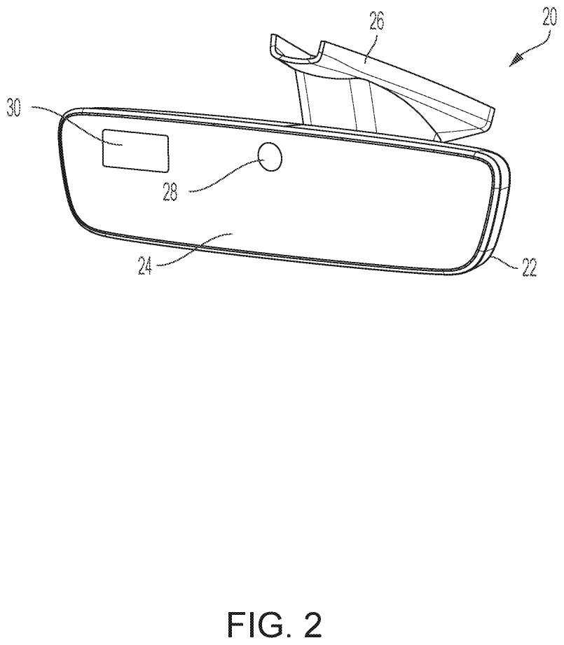

FIG. 2 illustrates an exemplary interior rearview mirror assembly 20 of the equipped vehicle 10. The interior rearview mirror assembly 20 includes a casing 22 and a reflective element 24 positioned at a front portion of the casing 22 (FIG. 2). The reflective element 24 may comprise an electro-optic reflective element, such as an electrochromic reflective element, having a variable reflectance. In the illustrated exemplary implementation, the mirror assembly 20 is configured to be adjustably mounted to an interior portion of the vehicle 10 (such as to an interior or in-cabin surface of a vehicle windshield or a headliner of the vehicle 10 or the like) via a mounting structure or mounting configuration or assembly or stay 26. The casing 22 may be pivotally attached to the stay 26 via one or more motorized actuators configured to automatically adjust a position of the casing 22 and the reflective element 24. The system includes an interior-viewing imaging sensor or camera 28 (which may be the same as, or an implementation of, camera 14) disposed at and movable with a mirror head of the interior rearview mirror assembly 20. For example, the camera 28 may be disposed behind the mirror reflective element 24 and view through the mirror reflective element 24 for capturing image data representative of the interior cabin of the vehicle 10, including a head region of the driver and an occupant region of the vehicle cabin. The reflective element 24 may comprise a transflective portion configured to transmit light to a lens of the camera 28. The system may utilize aspects of driver monitoring systems or occupant monitoring systems described in U.S. Pat. Nos. 11,930,264; 11,827,153; 11,780,372 and/or 11,639,134 and/or International Publication No. WO 2023/220222, which are all hereby incorporated herein by reference in their entireties. The mirror assembly 20 may include one or more infrared (IR) or near-infrared (NIR) light emitter(s) 30 that, responsive to being electrically powered to emit light, emit near-infrared light passing through the reflective element 24 to illuminate the head region of the driver and passengers of the vehicle 10. The one or more NIR light emitters 30 may be synchronized with an exposure window of the camera 28 to capture the image data of the driver independent of ambient lighting conditions.

Implementations herein include a DMS or occupant monitoring system (OMS) or driver comfort system (DCS) or vehicular vision system including an artificial intelligence (AI) model trained to perform automatic alignment of the rearview mirror to increase a rear view of the driver based on eye position and a field of vision of the driver. The AI model may comprise a machine learning algorithm, a convolutional neural network (CNN), or a deep learning framework. An AI-based algorithm may automatically determine a rearview mirror orientation or configuration (i.e., a current position of the rearview mirror relative to a fixed position and the driver) and align the rearview mirror to the field of vision of the driver responsive to the driver entering the vehicle 10. The AI-based algorithm may calculate a reflection vector originating from the determined eye position of the driver, reflecting off a surface of the reflective element 24, and extending through a center of a rear window of the vehicle 10. The driver may confirm the AI-determined rearview mirror alignment via a human machine interface (HMI), or the driver may request that the AI model recalculate or redetermine the rearview mirror alignment responsive to the initial alignment determination deviating from a preference of the driver. The DMS may save the driver-confirmed position of the rearview mirror in an electronic memory as a user profile and return the rearview mirror to the saved position responsive to the driver beginning a subsequent driving cycle. The system may automatically align the mirror reflective element 24 and the mirror head of the interior rearview mirror assembly 20 to provide a rearward view of the driver through the rear window of the vehicle 10, and the system may automatically align the mirror reflective element and the mirror head of an exterior rearview mirror assembly to provide the rearward view of the driver along one or both sides of the vehicle 10. Adjusting the exterior rearview mirror assembly may include aligning the field of vision of the driver to encompass adjacent traffic lanes.

Manual rearview mirror alignment involves the driver grasping the mirror head of the interior rearview mirror assembly 20 and twisting, turning, or tilting the mirror head, such that the driver may view objects through the rear window of the vehicle 10. Manual adjustment by the driver while operating the vehicle 10 may increase distraction of the driver and risk of a collision with objects surrounding the vehicle 10. Automatic rearview mirror alignment via the AI-based algorithm reduces instances of the driver diverting attention of the driver from a roadway by automatically aligning the rearview mirror to the eye position of the driver responsive to the driver entering the vehicle 10. Automatic alignment may be performed responsive to the vehicle electronics being enabled in an accessory-mode of the vehicle 10, responsive to the driver entering the vehicle 10, or responsive to the driver starting the vehicle 10 (i.e., turning on a vehicle ignition, enabling a propulsion system of the vehicle 10, starting the vehicle 10, etc.). Automatically aligning the reflective element 24 of the rearview mirror reduces instances of the driver becoming distracted by an unaligned mirror position. Responsive to the head position of the driver changing due to a seat adjustment by the driver or a posture change by the driver, the system may automatically determine a change in head position (such as by episodically processing captured image data and comparing the processed image data to initial captured image data) and may automatically re-align the reflective element 24. Determining the change in the head position may include identifying a coordinate deviation of the eye position of the driver exceeding a distance threshold in three-dimensional space.

Automatic alignment of the rearview mirror reduces instances of the driver beginning a driving cycle without aligning the rearview mirror to the field of vision of the driver. Accordingly, automatic alignment of the rearview mirror may assist the driver in avoiding rear-end collisions of the vehicle 10 (e.g., in reverse maneuvers), assist the driver in avoiding collisions with overtaking vehicles in a lane-change maneuver, and reduce blind spots where the driver is unable to see surroundings of the vehicle 10. Reducing the blind spots may include coordinating the alignment of the interior rearview mirror assembly 20 with the alignment of the exterior rearview mirror assembly to provide a continuous, overlapping field of view around the vehicle 10. The AI model may determine rearview mirror alignment for a new driver operating the vehicle 10. Automatic rearview mirror alignment provides a customized driving configuration for multiple drivers of the vehicle 10. By recognizing a specific driver via facial recognition processing of the captured image data, the system may automatically access a corresponding user profile and automatically adjust the rearview mirror to match the physical dimensions and seating preferences of the specific driver.

The AI model may be trained based on a training set of image data including drivers seated in the driver's seat of the vehicle 10 and an optimized rearview mirror position for each respective driver of the training set. The training set may comprise thousands of annotated images correlating diverse seating postures and physical builds with corresponding optimal mirror angles. The AI model may define the AI-based algorithm based at least in part on a height of the driver and/or one or more bodily dimensions of the driver (e.g., torso length, neck length, head size, eye position, etc.). The system 12 may extract the one or more bodily dimensions by analyzing pixel coordinates of the captured image data and mapping the pixel coordinates to a three-dimensional spatial model of the interior cabin. The AI model may define the AI-based algorithm based at least in part on aspects of a model of the vehicle 10, including vehicle type (e.g., sedan, crossover, sport utility vehicle (SUV), truck, etc.), a ride height of the vehicle 10, a width of the vehicle 10, dimensions of the rear window of the vehicle 10, dimensions of the rearview mirror of the vehicle 10, dimensions of one or more side mirrors of the vehicle 10, and/or orientation of the one or more side mirrors of the vehicle 10. The aspects of the model of the vehicle 10 may define a geometric relationship between a track position of the driver's seat, a mounting point of the interior rearview mirror assembly 20, and an aperture of the rear window. The AI model may further be trained or fine-tuned based on rearview mirror adjustments manually made by drivers of the vehicle 10. For example, manual overrides by the driver correcting the orientation determined by the AI model may serve as reinforcement learning feedback to continuously improve accuracy of the AI-based algorithm.

In some examples, the AI model is a closed model, such that the AI-based algorithm is defined based solely on the training set. A closed model architecture may feature static neural network weights stored in a read-only electronic memory of the ECU 16. Accordingly, a manufacturer of the vehicle 10 may train the AI model based on a curated training set and prevent changes to the AI-based algorithm independent of manufacturing updates to the system 12. Accordingly, the manufacturer may provide consistent algorithmic outputs of the system 12 among drivers. In other examples, the AI model may be an open model, such that the AI-based algorithm is further defined based on preferences of users of the vehicle 10. An open model architecture may utilize federated learning techniques to update the AI-based algorithm locally at the ECU 16. Optionally, the AI model may be refined based at least in part on data including preferences of drivers of the vehicle 10 and/or drivers across a plurality of vehicles of the same manufacturer, model, and/or vehicle type. That is, the AI model may be defined based at least in part on user preferences collected across a plurality of vehicles stored at a database (e.g., at a cloud database accessed via the Internet or other wireless communication). The system 12 may transmit anonymized adjustment data via a telematics control unit to the cloud database for aggregation. The AI model may be stored at the database associated with the vehicle 10. The system 12 may episodically synchronize local parameters of the ECU 16 with updated parameters retrieved from the cloud database.

Responsive to the AI model determining an orientation or configuration of the rearview mirror for the driver, the DMS 12 may adjust the mirror reflective element 24 and/or a mirror head using the determined orientation or configuration. The determined orientation or configuration may comprise specific pitch angles, yaw angles, and roll angles calculated to center a line of sight of the driver through the rear window of the vehicle 10. For example, the DMS 12 may provide one or more input signals to a mirror actuator having one or more electrical motors operatively coupled to the casing 22 and the reflective element 24 of the interior rearview mirror assembly 20. The one or more input signals may comprise pulse-width modulation (PWM) signals directed to a controller of the mirror actuator. The one or more electrical motors may actuate responsive to the one or more input signals, pivoting or translating the reflective element 24 within the casing 22 and/or rotating the casing 22 about the mounting structure 26 of the interior rearview mirror assembly 20. The one or more electrical motors may comprise stepper motors or direct current (DC) motors equipped with position encoders providing closed-loop feedback to the ECU 16 regarding a physical position of the reflective element 24. The actuator may adjust the rearview mirror vertically, horizontally, and/or pivotally about one or more axes, thereby adjusting and/or positioning the rearview mirror according to the orientation determined by the AI model. The mirror actuator may utilize aspects of the devices and systems described in U.S. Pat. Nos. 12,145,507; 11,214,199 and/or 10,442,360, and/or U.S. Publication No. US-2024-0383405, and/or U.S. patent application Ser. No. 18/987,113, filed Dec. 19, 2024 (Attorney Docket DON01 P5292), and/or U.S. provisional application Ser. No. 63/792,414, filed Apr. 22, 2025 (Attorney Docket DON01 P5394), which are all hereby incorporated herein by reference in their entireties.

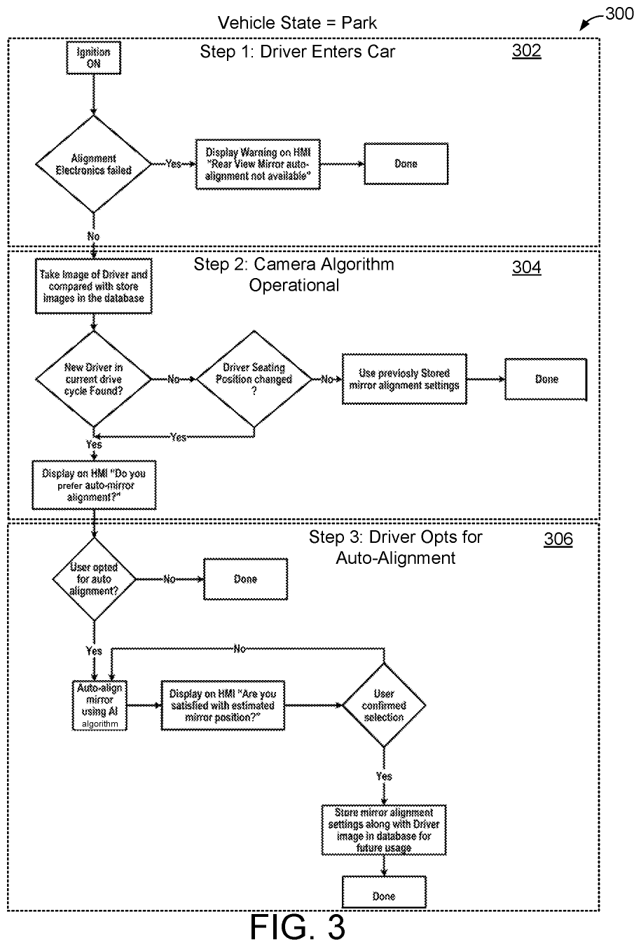

Referring to FIG. 3, a flowchart illustrates an exemplary method 300 of automatically aligning the rearview mirror via the AI-model of the DMS 12. In exemplary implementations, the DMS 12 may perform method 300 responsive to determining the vehicle 10 is not moving (e.g., responsive to determining a transmission of the vehicle 10 is in a park state). At operation 302, a driver enters the vehicle 10 and turns on an ignition and/or starts the vehicle 10. The system is enabled and determines whether electronics associated with automatic alignment of the rearview mirror are operational and functioning properly. Determining whether the electronics are operational may include transmitting diagnostic signals to a motor actuator of the interior rearview mirror assembly 20, verifying communication with the interior-viewing camera 14, and checking for diagnostic trouble codes (DTCs) within the ECU 16. Responsive to the system determining that one or more electronics associated with automatic alignment have failed or are not operational, the system may warn the driver via a human machine interface (HMI) that a rearview mirror automatic alignment feature is unavailable. The system may provide the warning as an audio and/or a visual message, such as via text displayed at a screen of an infotainment system of the vehicle 10. Providing the visual message may comprise generating a graphical user interface (GUI) element at a center console display. For example, the warning may state “rearview mirror auto-alignment not available.” The system terminates the automatic alignment method responsive to providing the warning.

At operation 304, responsive to determining that the electronics associated with the automatic alignment of the rearview mirror are operational, the DMS 12 captures image data of the driver via the interior-viewing camera 14. Capturing the image data may comprise capturing a stream of video frames using the CMOS imaging array of the camera 14 while illuminating the interior cabin with the NIR light emitter 30. The system compares the captured image data to stored image data including images of one or more drivers associated with the vehicle 10. Comparing the captured image data to the stored image data may include extracting a facial feature vector from the captured image data and executing a comparative algorithm against stored facial feature vectors. Optionally, the stored image data may be located at the database including the AI model. The database may include profiles of the one or more associated drivers. The system may store any number of profiles for any number of drivers at the database. The database may be stored local to the vehicle 10 (e.g., at an on-board flash memory of the ECU 16) or remote from the vehicle 10 (e.g., at a cloud database accessed via the Internet or other wireless communication using a telematics transceiver of the vehicle 10). Each profile may include information (e.g., biometric information) to allow the system to recognize the associated driver (e.g., via facial recognition), as well as an optimal rearview mirror alignment setting and/or a seating position of the driver's seat for the associated driver. The biometric information may comprise inter-ocular distance, facial landmark coordinates, or jawline geometry.

Responsive to comparing the captured image data to the stored image data of the one or more associated drivers, the DMS 12 determines whether the driver is associated with one of the driver profiles (i.e., whether the driver is an associated driver of the vehicle 10). Responsive to the system determining that a current driver is associated with a stored driver profile, the system may determine whether a current position of the driver's seat matches the seating position stored in the driver profile, as the seating position affects an eye position of the driver. Determining the current position of the driver's seat may include receiving seat position data from seat track sensors or seat motor encoders via the communication link of the vehicle 10. The system may determine that the current position matches the seating position responsive to the current position falling within a predefined spatial tolerance threshold of the seating position stored in the driver profile. Responsive to the current position of the driver's seat matching the seating position stored in the driver profile, the system adjusts the rearview mirror to the previously stored rearview mirror alignment setting and terminates the automatic alignment method. Adjusting the rearview mirror may include transmitting one or more actuation commands from the ECU 16 to the motor actuator to reproduce exact pitch and yaw angles saved in the stored driver profile.

Responsive to the system determining that the current position of the driver's seat deviates from the seating position stored in the driver profile, or responsive to the system determining that the driver is a new driver unassociated with the vehicle 10 or the driver profile, the system may prompt the driver for input as to whether the driver requests the system to perform rearview mirror auto-alignment. The deviation of the current position from the seating position may comprise a physical distance exceeding the predefined spatial tolerance threshold. For example, the system may provide, via the HMI, an audio and/or visual message stating, “do you prefer auto-mirror alignment?” The system may receive the input from the driver via a touch screen interface, a physical button located at a steering wheel of the vehicle 10, or a voice command captured by a microphone disposed within the interior cabin of the vehicle 10. In exemplary implementations, the system may automatically (i.e., without driver input) perform the alignment. For example, the system may be configured (by a user or owner of the vehicle 10) to automatically perform alignment independent of prompting the user. Configuring the system to automatically perform the alignment may include storing a global preference flag within a non-volatile memory of the ECU 16.

At operation 306, the DMS 12 may receive input from the driver indicating whether the driver requests the system to perform rearview mirror auto-alignment. Receiving the input may comprise receiving a signal generated by a touch screen interface, a physical switch, or a microphone capturing a voice command processed by a natural language processing module of the ECU 16. Responsive to receiving driver input indicating that the driver declines the system performing the rearview mirror auto-alignment, the system terminates the automatic alignment method. In exemplary implementations, responsive to the driver failing to respond to a prompt within a threshold amount of time, the system may terminate the automatic alignment method. Terminating the automatic alignment method may comprise maintaining a current physical orientation of the interior rearview mirror assembly 20 and transitioning the ECU 16 to a standby state. For example, the threshold amount of time may be a value within the range of 5 seconds to 30 seconds, and the threshold amount of time may be stored as a predetermined duration within an electronic memory of the ECU 16.

Responsive to receiving driver input indicating that the driver requests the system to perform rearview mirror auto-alignment (or responsive to automatically performing the alignment independent of driver input), the system may, via the AI model, perform or execute the AI-based algorithm to automatically align the rearview mirror to the eye position of the driver and a field of vision of the driver. Executing the AI-based algorithm may comprise calculating a specific pitch angle and a specific yaw angle for the reflective element 24 based on spatial coordinates of the eye position of the driver relative to a structural frame of the vehicle 10. Responsive to aligning the rearview mirror to the eye position of the driver, the system prompts the driver for input regarding whether the driver is satisfied with the rearview mirror alignment. Prompting the driver may include generating a graphical user interface prompt comprising a confirmation button and a rejection button at a center console display. For example, the system may provide, via a human machine interface (HMI), an audio message and a visual message stating a request to confirm an estimated mirror position.

Responsive to receiving driver input indicating that the driver is unsatisfied with the rearview mirror alignment, the DMS 12 may perform an additional iteration of automatic alignment. Performing the additional iteration may comprise adjusting the AI-based algorithm using an incremental correction factor to shift a calculated focal point of the interior rearview mirror assembly 20. The additional iteration of automatic alignment may result in an additional rearview mirror alignment having orientation coordinates different from a first rearview mirror alignment. Responsive to completing the additional iteration of automatic alignment, the system may prompt the driver for input indicating whether the driver is satisfied with the additional rearview mirror alignment. The system may perform a plurality of iterations of alignment responsive to receiving input indicating the driver is unsatisfied, and the system may cease performing the plurality of iterations of alignment responsive to the driver confirming an acceptable rearview mirror alignment via the HMI. Alternatively, the driver may perform a manual adjustment of the reflective element 24, and the ECU 16 may record the manual adjustment as the acceptable rearview mirror alignment.

Responsive to the driver confirming the rearview mirror alignment, the system may store a confirmed rearview mirror alignment setting locally at the electronic memory of the ECU 16 and at the cloud database. Storing the confirmed rearview mirror alignment setting may comprise recording position encoder values associated with motor actuators of the interior rearview mirror assembly 20. Optionally, the system may store a position of the driver's seat corresponding with the position of the driver's seat associated with the confirmed rearview mirror alignment setting. Responsive to determining the driver is a new driver, the system may store information (e.g., biometric information) configuring the system to recognize the driver at an additional driving cycle. The biometric information may comprise a facial mapping profile or an inter-ocular distance measurement extracted from the captured image data. Responsive to storing the rearview mirror alignment setting, the system may terminate the automatic alignment method. Terminating the automatic alignment method may comprise ceasing transmission of actuation signals to the interior rearview mirror assembly 20 and continuing to monitor the interior cabin of the vehicle 10.

The system automatically aligns a rearview mirror of the vehicle 10 based at least on the eye position of the driver and the position of the driver's seat to determine an optimal rearview mirror orientation. The system may perform the alignment of the rearview mirror responsive to the vehicle 10 occupying a parked vehicle state, reducing instances of the driver manually aligning the rearview mirror responsive to the vehicle 10 occupying an active driving state. Providing the automatic rearview mirror alignment comprises establishing a specific orientation of the reflective element 24 correlating with physical dimensions of the driver of the vehicle 10. The system reduces a non-visible area adjacent to the vehicle 10 by using the AI-based algorithm to perform the automatic alignment. The AI-based algorithm determines a target coordinate for the rearview mirror based on one or more of the position of the driver's seat, the eye position of the driver, bodily dimensions of the driver, and physical aspects of the vehicle 10. Although the system has been described with respect to the interior rearview mirror assembly 20, the system described herein may be applied to an adjustable mirror of the vehicle 10, such as exterior side-view mirrors. Applying the system to the exterior side-view mirrors may comprise capturing image data of a side region of the vehicle 10 and determining yaw angles and pitch angles for reflective elements of the exterior side-view mirrors. The system may utilize aspects described in U.S. Pat. No. 11,465,561 and/or U.S. patent application Ser. No. 18/983,552, filed Dec. 17, 2024 (Attorney Docket MAG04 P5286), which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. provisional application Ser. No. 63/673,225, filed Jul. 19, 2024 (Attorney Docket DON01 P5202), and/or U.S. provisional application Ser. No. 63/641,574, filed May 2, 2024 (Attorney Docket DON01 P5156), and/or International Publication No. WO 2023/220222, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The coaxial cable provides bi-directional communication between the mirror head and the ECU that is located at the vehicle remote from the mirror head. For example, the coaxial cable may provide power from the ECU to the mirror head and may provide control signals or data to the mirror head, and may receive image data from the camera at the mirror head. The coaxial cable and electronic connection between the ECU and the mirror head may utilize aspects of the systems described in U.S. Pat. Nos. 10,567,705; 10,298,823; 10,099,614; 10,089,537; 9,900,490 and/or 9,609,757, which are hereby incorporated herein by reference in their entireties. Thus, the bi-directional coaxial cable may commonly carry (i) image data captured by the DMS camera from the mirror head to the ECU, (ii) control signals from the ECU to the mirror head (such as for controlling the camera and/or a light emitter and/or dimming circuitry of the mirror head), and (iii) electrical power from a DC power supply of (or connected to) the ECU to the mirror head.

Optionally, the driver monitoring system may be integrated with a camera monitoring system (CMS) of the vehicle. The integrated vehicle system incorporates multiple inputs, such as from the inward-viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward-viewing camera may comprise a rear backup camera of the vehicle or may comprise a centrally located higher mounted camera (such as at a center high-mounted stop lamp (CHMSL) of the vehicle), whereby the rearward-viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0245662; US-2021-0162926; US-2021-0155167; US-2018-0134217 and/or US-2014-0285666, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0245662; US-2021-0162926; US-2021-0155167 and/or US-2019-0118717, which are all hereby incorporated herein by reference in their entireties.

Changes and modifications in the specifically described embodiments can be carried out without departing from the principles of the disclosure, which is intended to be limited only by the scope of the appended claims, as interpreted according to the principles of patent law including the doctrine of equivalents.

1. A vehicular driver monitoring system, the vehicular driver monitoring system comprising:
a camera disposed at an interior cabin of a vehicle equipped with the vehicular driver monitoring system and viewing at least a portion of a driver of the vehicle, wherein the camera is operable to capture image data;
wherein the camera comprises an imager;
an electronic control unit (ECU) comprising electronic circuitry and associated software;
wherein the electronic circuitry of the ECU comprises an image processor for processing image data captured by the camera;
wherein the vehicular driver monitoring system, responsive to processing at the ECU of image data captured by the camera, determines an eye position of the driver within the interior cabin of the vehicle;
wherein the vehicular driver monitoring system determines an orientation for a mirror reflective element of a rearview mirror of the vehicle based at least in part on (i) the determined eye position of the driver and (ii) a position of a driver's seat of the vehicle; and
wherein the vehicular driver monitoring system adjusts the mirror reflective element of the rearview mirror of the vehicle using the determined orientation of the mirror reflective element of the rearview mirror of the vehicle.

2. The vehicular driver monitoring system of claim 1, wherein the vehicular driver monitoring system comprises an AI model that determines the orientation of the mirror reflective element of the rearview mirror based at least in part on at least one selected from the group consisting of (i) a height of the driver, (ii) a torso length of the driver, (iii) a neck length of the driver and (iv) a head size of the driver.

3. The vehicular driver monitoring system of claim 1, wherein the vehicular driver monitoring system comprises an artificial intelligence (AI) model that determines the orientation of the mirror reflective element of the rearview mirror based at least in part on at least one selected from the group consisting of (i) a model of the vehicle, (ii) a type of the vehicle, (iii) a ride height of the vehicle, (iv) a width of the vehicle, (v) dimensions of a rear window of the vehicle, (vi) dimensions of the rearview mirror, (vii) dimensions of one or more side mirrors of the vehicle and (viii) an orientation of the one or more side mirrors of the vehicle.

4. The vehicular driver monitoring system of claim 1, wherein the vehicular driver monitoring system determines the orientation of the mirror reflective element of the rearview mirror responsive to determining that the driver of the vehicle does not have a profile comprising (i) a stored orientation for the mirror reflective element of the rearview mirror and (ii) a stored position of the driver's seat.

5. The vehicular driver monitoring system of claim 4, wherein the vehicular driver monitoring system determines that the driver of the vehicle does not have the profile based on facial recognition.

6. The vehicular driver monitoring system of claim 1, wherein the vehicular driver monitoring system generates a profile for the driver, and wherein the profile comprises (i) the determined orientation for the mirror reflective element of the rearview mirror and (ii) the position of the driver's seat.

7. The vehicular driver monitoring system of claim 1, wherein the vehicular driver monitoring system determines the orientation of the mirror reflective element of the rearview mirror responsive to the driver indicating that the driver would like the vehicular driver monitoring system to adjust the mirror reflective element of the rearview mirror.

8. The vehicular driver monitoring system of claim 1, wherein the vehicular driver monitoring system determines that the driver of the vehicle has a profile comprising (i) a second determined orientation for the mirror reflective element of the rearview mirror and (ii) a second position of the driver's seat, and wherein the vehicular driver monitoring system, responsive to determining that the position of the driver's seat of the vehicle does not match the second position of the driver's seat, determines the orientation for the mirror reflective element of the rearview mirror.

9. The vehicular driver monitoring system of claim 8, wherein the vehicular driver monitoring system, responsive to determining that the position of the driver's seat does not match the second position of the driver's seat, updates the profile to include (i) the determined orientation for the mirror reflective element of the rearview mirror and (ii) the position of the driver's seat.

10. The vehicular driver monitoring system of claim 1, wherein the vehicular driver monitoring system adjusts the mirror reflective element of the rearview mirror of the vehicle responsive to determining that the vehicle is in a parked vehicle state.

11. The vehicular driver monitoring system of claim 1, wherein the vehicular driver monitoring system, responsive to receiving input from the driver indicating that the driver is unsatisfied with the orientation of the mirror reflective element of the rearview mirror, determines a second orientation for the mirror reflective element of the rearview mirror.

12. The vehicular driver monitoring system of claim 1, wherein the rearview mirror comprises an interior rearview mirror assembly.

13. The vehicular driver monitoring system of claim 1, wherein the rearview mirror comprises an exterior rearview mirror assembly.

14. A method for automatically aligning a rearview mirror of a vehicle, the method comprising:
capturing, via a camera disposed at an interior cabin of the vehicle, image data of at least a portion of a driver of the vehicle, wherein the camera comprises an imager;
processing, via an electronic control unit (ECU) comprising an image processor, the captured image data;
determining, via the ECU and responsive to the processing of the captured image data, an eye position of the driver within the interior cabin of the vehicle;
determining, via the ECU, an orientation for a mirror reflective element of the rearview mirror of the vehicle based at least in part on (i) the determined eye position of the driver and (ii) a position of a driver's seat of the vehicle; and
adjusting the mirror reflective element of the rearview mirror of the vehicle using the determined orientation of the mirror reflective element of the rearview mirror of the vehicle.

15. The method of claim 14, wherein determining the orientation for the mirror reflective element of the rearview mirror comprises executing an artificial intelligence (AI) model that determines the orientation based at least in part on at least one selected from the group consisting of (i) a height of the driver, (ii) a torso length of the driver, (iii) a neck length of the driver and (iv) a head size of the driver.

16. The method of claim 14, wherein determining the orientation for the mirror reflective element of the rearview mirror comprises executing an artificial intelligence (AI) model that determines the orientation based at least in part on at least one selected from the group consisting of (i) a model of the vehicle, (ii) a type of the vehicle, (iii) a ride height of the vehicle, (iv) a width of the vehicle, (v) dimensions of a rear window of the vehicle, (vi) dimensions of the rearview mirror, (vii) dimensions of one or more side mirrors of the vehicle and (viii) an orientation of the one or more side mirrors of the vehicle.

17. The method of claim 14, wherein determining the orientation for the mirror reflective element of the rearview mirror is performed responsive to determining that the driver of the vehicle does not have a profile comprising (i) a stored orientation for the mirror reflective element of the rearview mirror and (ii) a stored position of the driver's seat.

18. The method of claim 17, further comprising determining that the driver of the vehicle does not have the profile based on facial recognition processing of the captured image data.

19. The method of claim 14, further comprising generating a profile for the driver, wherein the profile comprises (i) the determined orientation for the mirror reflective element of the rearview mirror and (ii) the position of the driver's seat.

20. The method of claim 14, wherein determining the orientation for the mirror reflective element of the rearview mirror is performed responsive to receiving input from the driver indicating that the driver requests adjustment of the mirror reflective element of the rearview mirror.
